(19) United States
(12) Patent Application Publication
(10) Pub. No.: US 2006/0292358 A1
(43) Pub. Date: Dec. 28, 2006

(54) WATER RESISTANT LOW DENSITY CEMENTITIOUS PANEL

(75) Inventors: Craig C. Robertson, Charlotte, NC (US); James Hickey, St. Augustine, FL (US); Marie-Andree Mathieu, Granby (CA)

Correspondence Address: ICE MILLER LLP, ONE AMERICAN SQUARE, SUITE 3100, INDIANAPOLIS, IN, 46282-0200, US

(73) Assignee: National Gypsum Properties, LLC, Charlotte, NC (US)

(21) Appl. No.: 11/421,674

(22) Filed: Jun. 1, 2006

Related U.S. Application Data
(60) Provisional application No. 60/686,498, filed on Jun. 1, 2005.

(51) Int. Cl. B28B 3/00

(52) U.S. Cl. 428/312.4; 264/333

(57) ABSTRACT

A cementitious panel with a low density core that can include at least one lightweight particulate aggregate filler, at least one binder, and at least one air entraining agent. The core of the cementitious panel can further comprise a rheological admixture, a standard weight aggregate filler, and/or synthetic and/or natural fibers. The method of forming such a cementitious panel involves forming a cementitious slurry, covering a reinforcing mesh with a portion of the cementitious slurry, forming a core by mixing together at least one lightweight particulate aggregate filler, and at least one air entraining agent, and introducing the core on top of the slurry covered mesh.

### CROSS-REFERENCE TO RELATED APPLICATIONS

This application claims the benefit of U.S. Provisional Application No. 60/ 686,498, filed Jun. 1, 2005.

### BACKGROUND OF INVENTION

The subject invention generally relates to cementitious panels used in the construction industry. In general, a cementitious panel or board may be fastened to a wall frame for the construction of a wall, particularly a wall where high moisture conditions are encountered. The cementitious panels are commonly screwed or nailed into a wall frame and typically serve as long lasting substrates for humid or wet areas and provide high impact resistance. For example, a reinforced cementitious panel may be used as a substrate or backer board in wet or humid areas, such as bath rooms, shower walls, locker rooms, swimming pool rooms, and building exterior walls. Once such a panel is affixed to a wall frame, a wall facing material may be affixed thereto such as, for example, ceramic tile, thin brick, thin marble panels, stucco, or the like.

While such cementitious panels are generally stable and water resistant, they are not an ideal construction panel for use in wet environments due to several inherent limitations. For example, while cementitious panels are well-suited for the use as backer boards in the construction industry, the weight associated with the panels is problematic. Heavy or high-density cementitious panels are more costly and difficult to manufacture, transport, store, and manually install at job sites. Accordingly, many attempts have been made to reduce the weight and density associated with standard cementitious panels without sacrificing the overall strength and integrity of the cementitious panel. While some progress has been made, it is still desirable to further reduce the weight without reducing the strength of the panel.

Thus, it would be advantageous to develop a cementitious composition that allowed for the production of more lightweight cementitious panels to further reduce the costs associated with the use of cementitious panels. Moreover, it would be advantageous to produce a method for producing such a cementitious composition and cementitious panel.

### BRIEF INVENTION SUMMARY

The subject invention discloses a cementitious panel and a method for making the same. One embodiment of the cementitious panel comprises a low density core that includes at least one lightweight particulate aggregate filler in the amount of about 0.5 to about 10 weight percent of the low density core, at least one binder in the amount of about 30 to about 80 weight percent of the low density core, and at least one air entraining agent in the amount of about 0.01 to about 1 weight percent of the low density core. Examples of suitable lightweight aggregate fillers include, but are not limited to, pumice, expanded shale, expanded clay, expanded polystyrene beads, poly vinyl chloride, vinyl acetate, poly-eurethane, blast furnace slag, ceramic beads, glass beads, and mixtures thereof. Examples of binders include, but are not limited to, Types I, II, III, IV and V Portland cement, sulfate cement, phosphate cement and mixtures thereof. Moreover, the binder can comprise any of the listed cements blended with a pozzolanic material, such as, class C or Class F fly ash, slag, pumice, silica fume, magnesium silicates, aluminum silicates, and mixtures thereof. The binder can also solely comprise of just fly ash. Examples of suitable air entraining agents include, but are not limited to, sodium alkyl sulfate, sodium lauryl sulfate, alkyl dimethyl sulfate, amino oxide, alpha olephin sulfonate, or mixtures thereof. The air entraining agent should also have a Hydrophilic-Lipophilic Balance value ranging from 5 to 20. The cementitious panel can have a density of ranging from about 37 to 72 pounds/cubic foot.

The core of the cementitious panel can further comprise a rheological admixture. Suitable Theological admixtures include but are not limited to melamine sulfonate, cellulose polymer derivatives, hydroxyl-ethyl cellulose, methyl cellulose, hydroxyl-propyl methyl cellulose, guar gum, wellan gum, xanthan gum, sodium naphthalene sulfonate, lingnosulfonates, and mixtures thereof. The core of the cementitious panel can also comprise a standard weight aggregate filler in the amount of about 0.01 to about 50 weight percent of the low density core. Moreover, the core of the cementitious panel can completely exclude all standard weight aggregate fillers.

One embodiment of the method of forming such lightweight cementitious panel comprises the step of forming a cementitious slurry by mixing together cement in the amount of about 75 to about 85 wt. % of the slurry, water in the amount of about 5 to about 10 wt. % of the slurry, a plasticizer in the amount of about 0 to about 1 wt. %, and a setting admixture in the amount of about 5 to about 10 wt. % of the slurry and then covering a first reinforcing mesh with a portion of the cementitious slurry. The method also involves the step of forming a core by mixing together at least one lightweight particulate aggregate filler in the amount of about 0.5 to about 10 weight percent of the core, at least one binder in the amount of about 30 to about 80 weight percent of the core; and at least one air entraining agent in the amount of about 0.01 to about 1 weight percent of the low density core and introducing the core on top of the slurry covered mesh. The core and first slurry covered mesh can then be passed under forming rolls so that the core is extruded on top of the first slurry covered mesh at a desired thickness and width. If desired, a second reinforcing mesh can be adhered on top of the core with a portion of the cementitious slurry and if further desired, another portion of the cementitious slurry can be deposited and distributed at a predetermined thickness on top of the second reinforcing mesh to create a second slurry covered mesh.

### DETAILED DESCRIPTION OF THE INVENTION

The subject invention is directed towards cementitious panels and methods for their preparation. According to the subject invention, a composition is provided that is particularly useful in areas where water resistance is an important consideration. One exemplary embodiment of the subject invention is directed towards a low density cementitious panel comprising a core mix with a binder made up of a hydraulic cement blended with a pozzolanic material, lightweight and/or normal weight aggregates, a Theological admixture, synthetic and/or natural fibers, and water.

Although not required, synthetic and/or natural fibers can be added to the core mix of the cementitious panel composition in the amount of about 0 to about 3 percent of the total weight (“wt. %”) of the core mix to ensure core integrity. Suitable synthetic and/or natural fibers include, but are not limited to cellulose, hemp, cotton, polyester, polypropylene, NYLON® fibers, alkali resistant (AR) glass fibers, Standard (E) glass fibers, or any combinations thereof. It will be appreciated by one skilled in the art that fibers with similar or different length/diameter ratios can be used in the core mix. However, the fibers should be no longer than ¾ inches in length.

About 30 to about 80 wt. % of the core mix of this embodiment comprises the binder. While a hydraulic cement or fly ash by itself can be used as the binder, the binder in this embodiment comprises a cement combined with a pozzolanic material. For example, suitable cements can include, but are not limited to, any of Types I, II, III, IV or V Portland cement, sulfate cement, phosphate cement or any mixtures thereof. This embodiment utilizes either a Type I and/or a Type II Portland cement to make up the binder. Any number of pozzolanic materials known in the art can be blended with such a cement or cement mixture to create the binder. For example, suitable pozzolanic materials include, but are not limited to, fly ash (class C or F), slag, pumice, silica fume, magnesium silicates, or aluminum silicates. In this embodiment, fly ash, class F, can be blended with the Type I and/or Type II Portland cement to create the binder or fly ash can be used by itself to create the binder.

In this embodiment, the aggregate fillers of the core mix include a standard weight aggregate filler in the amount of about 0 to about 50 wt. % of the core mixture and a lightweight aggregate filler in the amount of about 0.5 to about 10 wt % of the core mixture. The particle size distribution of the aggregate fillers may vary over a wide range. For example, the aggregate fillers might make up about ⅓ or smaller of the thickness of the panel. The aggregates are held/fused together by the binder to form the core of the cementitious panel.

Standard weight aggregate fillers are used to provide strength to the board and are components that can be sized to result in a cementitious panel of desirable strength and physical properties. Any number of known standard weight aggregate fillers can be used in the core mix for the cementitious panel. For example, suitable standard weight aggregate fillers include, but are not limited to, concrete or mortar grade sand, limestone, shale, clay, expanded shale, expanded clay, recycled concrete and granite, or any mixtures thereof. The normal weight aggregate filler used in the core mixture may be selected in accordance with the desired density and/or strength of the finished cementitious panel. In this embodiment, mortar sand can be used in the core mix.

To reduce the weight and density of the board, lightweight aggregate fillers can be used. Such lightweight aggregate fillers can include, but are not limited to, pumice, expanded clay, expanded shale, perlite, vermiculite, Polyvinyl chloride, polystyrene vinyl acetate, poly-eurethane, blast furnace slag, ceramic beads, glass beads, expanded polystyrene beads, and silicate beads. Polystyrene preferably is expanded to the desired density with a tolerance of 0.1 lb per cubic foot. The lightweight aggregate filler used in the cementitious panel composition may be selected in accordance with the desired density of the finished cementitious panel. In this embodiment, a combination of expanded polystyrene and vermiculite can be used in the core mix.

The core mix may also include a number of other components. In this embodiment, a suitable air entrainment or foaming agent in the amount of about 0.01 to about 1.0 wt. % of the core mix is included. The air entrainment or foaming agent can be any number of surfactants having Hydrophilic-Lipophilic Balance values ranging from 5 to 20 and that produce the desired degree of air entrainment in the cementitious panel composition. Suitable foaming agents usually are ones that work at high pH values and ones that work in compositions with high calcium concentrations. The principal characteristic of any foaming agent used is that it provides stable air bubbles having walls of a certain strength ensuring bubble stability. For example, suitable air entrainment agents/foaming agents include, but are not limited to, sodium alkyl sulfate, sodium lauryl sulfate, alkyl dimethyl sulfate, amino oxide, alpha olephin sulfonate, or mixtures thereof. In this embodiment, amino oxide, alkyl dimethyl sulfate or mixture of the two can be added to the core mix.

The weight of cementitious panels can be further reduced by utilizing the above-described foaming agent to increase the volume of the core mix. Such an increase in volume makes it possible to reduce and/or eliminate the use of standard weight aggregate fillers from the core mix and at the same time, increase the amount of lightweight aggregate fillers used in the core mix. Even though the amount of lightweight aggregate fillers is increased in the core mix and the amount of standard weight aggregate fillers are decreased and/or eliminated, the overall strength of the panel will still be maintained because the increased volume allows for the reinforcing mesh, as described below, to still be embedded in the core mix during the production of the panel. The use of the above-described foaming agents, thus, reduces the weight and density of the cementitious panel by replacing standard weight aggregate fillers with lightweight aggregate fillers. The standard cementitious panel has a normal density of 72 pounds/cubic foot (3 pounds/square foot for a ½ inch thick board). The density of the exemplary embodiments utilizing the above-described foaming agents can range from about 37 to 49 pounds/cubic foot (about 1.5 to 2.0 pounds/square foot for a ½ inch thick board). While it is preferred to keep the density in this range, the core mix can be adjusted to further reduce or increase the density of the cementitious panel. In this embodiment, the cementitious panel has a density of about 44 pounds/cubic foot (about 1.8 pounds/square foot for a ½ inch thick board).

Rheological admixtures can also be added to the core mix in the amount of about 0.1 to about 1.0 wt. % of the core mix to act as either a high range water reducer agent or as a viscosity modifier. Suitable Theological admixtures include, but are not limited to, melamine sulfonate, cellulose polymer derivatives (i.e. HEC, HPMC, EC), sodium naphthalene sulfonate, or lignosulfonates or any combinations thereof. In this embodiment, sodium naphthalene sulfonate is added to the cementitious panel composition and acts as a high range water reducer. In addition to a rheological admixture, drinkable quality water is used in the amount of about 10 to about 40 wt. % of the core mixture. Moreover, other components such as setting admixtures, to act as an accelerator or a retarder, can be added to the core mix. Suitable setting admixtures that can be added to the core include, but are not limited to, calcium-aluminate cement, lithium salts, sodium sulfate, sodium carbonate, calcium sulfate, calcium hydroxide, calcium nitrite, boric acid, formic acid, citric acid, sodium citrate, sodium gluconate, glucose, or any combinations thereof.

The manufacture of cementitious panels/boards are described in commonly-assigned U.S. Pat. No. 6,187,409, which is incorporated by reference in its entirety and in particular for its teachings related to the manufacture of cementitious boards/panels. In general, the manufacturing of the cementitious panels typically involves creating a cementitious slurry by mixing cement in the amount of about 75 to about 85 wt. % of the slurry, water in the amount of about 5 to about 10 wt. % of the slurry, a plasticizer in the amount of about 0 to about 1 wt. %, and a setting admixture in the amount of about 5 to about 10 wt. % of the slurry to act as an accelerator and/or a retarder. As used herein, the term “slurry” is to be understood as referring to a flowable mixture, e.g. a flowable mixture of water and hydraulic cement.

Suitable cements used in the creation of the core and slurry include, but are not limited to any of Types I, II, III, IV or V Portland cement or mixtures thereof. Suitable setting admixtures that can be added to the core and slurry include, but are not limited to, calcium-aluminate cement, lithium salts, sodium sulfate, sodium carbonate, calcium sulfate, calcium hydroxide, calcium nitrite, boric acid, formic acid, citric acid, sodium citrate, sodium gluconate, glucose, or any combinations thereof. In this embodiment, calcium cement and sodium citrate are added to the cementitious slurry in amounts of about 5 to about 10 wt. % of the slurry.

The slurry is introduced on to a continuously moving layer of a bottom reinforcing mesh of reinforcing fibers so that the slurry covers the mesh. The mesh comprises a woven or non-woven fabric (e.g. mat, fabric, tissue or the like) of natural or synthetic fibers and is used to reinforce the surface of the cementitious panel. As used herein, the term “woven” is to be understood as characterizing a material such as a reinforcing mesh that comprises fibers or filaments which are oriented and disposed in an organized fashion. In contrast, as used herein, the term “non-woven” is to be understood as characterizing a material such as a reinforcing mesh comprising non-oriented fibers or filaments being disposed in a random patter.

Suitable fibers that can be used to create the reinforcing mesh include, but are not limited to, NYLON® fibers, alkali resistant glass fibers, polymer coated glass fibers, polypropylene, polyester, cellulose, hemp, cotton, carbon, or any combinations thereof. In addition to the mesh reinforcing the surface of the core, an additional mesh can be used to add additional support for the longitudinal edges of the panel. The meshes for further supporting the longitudinal edges of the panel can be woven or non-woven and can include any number of the possible fibers listed above. The mesh size and fiber diameter may be selected according to the strength desired in the board and the size of the aggregate fillers in the core mix. A reinforcing mesh may, for example, have a relatively loose thread or mesh count per inch, such as for example from 4×4 to 18×18. In this embodiment, the cementitious panel composition utilizes meshes made up of polymer coated glass fibers to reinforce the surfaces of the cementitious panel and meshes made up of polypropylene to reinforce the longitudinal edges.

In this embodiment, the core mix, comprising the binder, the lightweight and normal weight (if any) aggregate fillers, fibers (if any), water, the foaming agent, and the rheological admixture, is introduced on top of the slurry covered bottom mesh. The core mix and slurry covered bottom mesh are then passed under a forming roll so that the core mix is extruded on top of the slurry covered bottom mesh at a given thickness and width. The core mix may be applied in any desired thickness. For example, the core mix may be applied to obtain a panel of the standard thicknesses of wallboard (e.g., thicknesses of ¼″, ⅜″, ½″, ⅝″, ¾″,and 1″, etc.) Although not required, another layer of reinforcing fibers (the top mesh) may be laid on top of the extruded core mix and adhered to the latter using a second portion of the cementitious slurry. Although not required, another portion of cementitious slurry may be deposited on and distributed across the top mesh to create a second slurry covered reinforcement layer of predetermined thickness. Although not required, in this embodiment, vibration is used to compact the cementitious panel and insure the top and bottom mesh bond with the core. The cementitious panel is then brought to an oven where it is heated to accelerate the curing of the panel so that the panel can be cut to its desired size and stacked on a skid. Final curing of the board will occur 2 to 7 days after its production, at which point it is ready for its final use.

The water resistance and reduced weight of the cementitious panels make the panel an ideal backer board for use in wet areas, such as bathrooms, shower walls, locker rooms, swimming pool rooms, and building exterior walls. Such cementitious panels may also be used as an intermediate sheathing board on exterior walls. It will be appreciated by one skilled in the art that this is just some of the examples of use of cementitious panels created in accordance with the subject invention.

The following tables are included to demonstrate some of the possible embodiments of the invention. It should be appreciated by those of ordinary skill in the art that the techniques disclosed in the examples which follow represent techniques discovered by the inventors to function well in the practice of the invention, and thus, can be considered to constitute preferred modes for its practice. However, those of ordinary skill in the art should, in light of the present disclosure, appreciate that many changes can be made in the specific embodiments which are disclosed and still obtain a like or similar result without departing from the spirit and scope of the invention.

TABLE I
Generic Core Sample Formula - Percentages in Weight

| Components | Sample I | Sample II | Sample III |
|---|---|---|---|
| Binders | 30-80% | 50-55% | 65-70% |
| Normal weight Aggregate | 0-50% | 23-30% | 0% |
| Lightweight Aggregate | 0.5-10% | 0.75-1.25% | 3-6% |
| Synthetic Fibers | 0-3% | 0.1-04% | 0-1% |
| High Range Water Reducer | 0.5-5% | 1.50-2.00% | 0.5-1% |
| Air entraining agent | 0.1-1% | 0.1-0.3% | 0.25-0.50% |
| Water | 10-40% | 10-20% | 20-30% |

TABLE II
Specific Core Sample Formula Examples - Percentages in Weight

| Components | Sample IV | Sample V |
|---|---|---|
| Type 1-2 Portland Cement | 37.4% | 52.2% |
| Aluminate Cement | 7.2% | 6.5% |
| Fly Ash | 10% | 10% |
| Sand | 26.9% | 0% |
| Polystyrene | 1.0% | 0.3% |
| Vermiculite | 0% | 2.2% |
| Polypropylene fibers | 0.3% | 0% |
| High Range Water Reducer | 1.7% | 0.9% |
| Air entraining agent | 0.2% | 0.4% |
| Water | 16.1% | 24.6% |

While the subject invention has been described in detail with reference to certain exemplary embodiments thereof, such are offered by way of non-limiting examples of the invention, as other versions are possible. It is anticipated that a variety of other modifications and changes will be apparent to those having ordinary skill in the art and that such modifications and changes are intended to be encompassed within the spirit and scope of the invention as defined by the following and any later added claims.

We claim:

1. A lightweight cementitious panel comprising:
(a) a low density core including:
(i) at least one lightweight particulate aggregate filler in the amount of about 0.5 to about 10 weight percent of the low density core;
(ii) at least one binder in the amount of about 30 to about 80 weight percent of the low density core; and
(iii) at least one air entraining agent in the amount of about 0.01 to about 1 weight percent of the low density core; and
(b) a first and second reinforcing mesh overlying the faces of the low density core, at least the first reinforcing mesh being covered with a cementitious slurry.

2. The cementitious panel of claim 1 wherein the lightweight aggregate filler is selected from a group consisting of pumice, expanded polystyrene beads, poly vinyl chloride, vinyl acetate, poly-eurethane, blast furnace slag, ceramic beads, glass beads, and mixtures thereof.

3. The cementitious panel of claim 1 wherein the binder comprises a hydraulic cement selected from a group consisting of Types I, II, III, IV and V Portland cement, sulfate cement and phosphate cement.

4. The cementitious panel of claim 1 wherein the binder comprises a hydraulic cement blended with a pozzolanic material selected from a group consisting of class C or Class F fly ash, slag, pumice, silica fume, magnesium silicates, aluminum silicates, and mixtures thereof.

5. The cementitious panel of claim 1 wherein the core further comprising at least one rheological admixture.

6. The cementitious panel of claim 5 wherein the Theological admixture is selected from a group consisting of melamine sulfonate, cellulose polymer derivatives, sodium naphthalene sulfonate, lingnosulfonates, and mixtures thereof.

7. The cementitious panel of claim 1, wherein the air entraining agent is selected from a group consisting of sodium alkyl sulfate, sodium lauryl sulfate, alkyl dimethyl sulfate, amino oxide, alpha olephin sulfonate, or mixtures thereof.

8. The cementitious panel of claim 1, wherein the cementitious panel has a density ranging from about 37 pounds/cubic foot to about 49 pounds/cubic foot.

9. The cementitious panel of claim 1, wherein the air entraining agent has a Hydrophilic-Lipophilic Balance value ranging from 5 to 20.

10. The cementitious panel of claim 1, wherein the low density core does not include a standard weight aggregate filler.

11. The cementitious panel of claim 1, wherein the low density core includes a standard weight aggregate filler in the amount of about 0 to about 50 weight percent of the low density core.

12. A low density core composition for a lightweight cementitious panel, the core composition comprising:
(a) at least one lightweight particulate aggregate filler in the amount of about 0.5 to about 10 weight percent of the core composition;
(b) at least one binder in the amount of about 30 to about 80 weight percent of the core composition; and
(c) at least one air entraining agent in the amount of about 0.01 to about 1 weight percent of the core composition.

13. The core composition of claim 12, wherein the air entraining agent is selected from a group consisting of sodium alkyl sulfate, sodium lauryl sulfate, alkyl dimethyl sulfate, amino oxide, alpha olephin sulfonate, or mixtures thereof.

14. The core composition of claim 12, wherein the air entraining agent has a Hydrophilic-Lipophilic Balance value ranging from 5 to 20.

15. The core composition of claim 12, wherein the low density core does not include a standard weight aggregate filler.

16. The core composition of claim 12, wherein the low density core includes a standard weight aggregate filler in the amount of about 0 to about 50 weight percent of the low density core.

17. A method for forming a lightweight cementitious panel comprising the steps of:
forming a cementitious slurry by mixing together cement in the amount of about 75 to about 85 wt. % of the slurry, water in the amount of about 5 to about 10 wt. % of the slurry, a plasticizer in the amount of about 0 to about 1 wt. %, and a setting admixture in the amount of about 5 to about 10 wt. % of the slurry;
covering a first reinforcing mesh with a first portion of the cementitious slurry to form a first slurry covered mesh;
forming a core by mixing together at least one lightweight particulate aggregate filler in the amount of about 0.5 to about 10 weight percent of the core, at least one binder in the amount of about 30 to about 80 weight percent of the core; and at least one air entraining agent in the amount of about 0.01 to about 1 weight percent of the low density core; and
introducing the core on top of the first slurry covered mesh.

18. The method of claim 17 further comprising the step of passing the core and first slurry covered mesh under forming rolls so that the core is extruded on top of the first slurry covered mesh at a desired thickness and width.

19. The method of claim 18 further comprising the step of adhering a second reinforcing mesh on top of the core with a second portion of the cementitious slurry.

20. The method of claim 19 further comprising the step of depositing and distributing a third portion of the cementitious slurry at a predetermined thickness on top of the second reinforcing mesh to create a second slurry covered mesh.
